(19) United States
(12) Patent Application Publication
(10) Pub. No.: US 2023/0368934 A1
(43) Pub. Date: Nov. 16, 2023

(54) Method for analyzing severe accident in nuclear reactor based on advanced particle method

(71) Applicant: XI`AN JIAOTONG UNIVERSITY, Xi'an Shaanxi (CN)

(72) Inventors: Ronghua Chen, Xi'an, Shaanxi (CN); Qinghang Cai, Xi'an (CN); Kailun Guo, Xi'an (CN); Wenxi Tian, Xi'an (CN); Guanghui Su, Xi`an (CN); Suizheng Qiu, Xi`an (CN)

(21) Appl. No.: 18/213,904

(22) Filed: Jun. 26, 2023

(30) Foreign Application Priority Data
Jul. 1, 2022 (CN) 202210768207.8

(51) Int. Cl. G21D 3/06; G21D 3/00

(52) U.S. Cl. CPC G21D 3/06; G21D 3/005

(57) ABSTRACT

A method for analyzing a sever accident in a nuclear reactor based on an advanced particle method includes steps of: 1) performing geometric modeling, setting initial conditions and boundary conditions; 2) updating material physical properties and key parameters; 3) performing mechanical structure module calculation, updating solid particle stress, strain, internal energy, displacement and velocity; 4) performing thermal hydraulic module calculation, updating fluid particle internal energy, position and velocity; 5) performing chemical reaction module calculation, updating particle matter composition and internal energy; 6) performing neutron physics module calculation, updating particle neutron flux density; and 7) outputting data. The method of the present invention is based on the discrete form of the advanced particle method, which is capable of accurately capturing cross-sectional changes, matter changes, and phase changes. Compared with grid method, the present invention can effectively avoid a mesh distortion problem existing in a large deformation.

### CROSS REFERENCE OF RELATED APPLICATION

The present invention claims priority under 35 U.S.C. 119(a-d) to CN 202210768207.8, filed Sep. 1, 2022.

### BACKGROUND OF THE PRESENT INVENTION

### Field of Invention

The present invention relates to a technical field of nuclear reactor severe accident analysis, and more particularly to a method for analyzing severe accidents in nuclear reactors based on an advanced particle method.

### Description of Related Arts

Nuclear energy is a clean, safe and reliable energy source. Nuclear power is a form of power generation using nuclear energy. Worldwide, due to the advantages of low resource consumption, low environmental impact and high supply capacity, nuclear power has become a top-three power supply method along with thermal power and hydropower. Conventionally, fossil energy accounts for more than 90% of China's energy structure. However, the environmental problems brought by coal and oil must be noticed. On Jan. 5, 2016, the State Council of PRC issued a notice on the “13th Five-Year Plan” for energy conservation and emission reduction, requiring that by 2020, national energy consumption per 10,000 yuan of GDP should drop by 15% compared with that of 2015, and chemical oxygen demand, ammonia nitrogen, sulfur dioxide and nitrogen oxide emissions should decrease by 10%, 10%, 15% and 15%, respectively, compared with those in 2015. The development of nuclear power can effectively promote the completion of energy conservation and emission reduction tasks.

As nuclear power becomes more and more developed and popular, the total installed capacity and power of reactors continues to increase, and their safety has become a major public concern. Since the birth of nuclear power, there have been twenty core meltdowns in military and commercial nuclear reactors worldwide, including the three well-known serious accidents at nuclear power plants: Three Mile Island in the United States (1979), Chernobyl in the former Soviet Union (1986) and Fukushima in Japan (2011). Core meltdown accidents can cause significant economic losses and may lead to radioactive material leakage, contaminating the surrounding environment and posing a public health hazard. Nuclear safety issues have become a basic premise and an important aspect of nuclear power development. Serious accidents in nuclear reactors may occur when the designed system cannot cope with operational failures or accidents. For example, both a small breach accident in the main circuit cooling system and a temporary failure in the emergency cooling system may lead to an exposed core, and the continuous release of core decay heat will keep the core to heat up. If the accident is not effectively mitigated, a serious accident of core meltdown may occur. The research of nuclear safety technology, especially the research of reactor serious accident prevention and mitigation technology, is of great significance for the optimal design and safe operation of nuclear power plants.

### SUMMARY OF THE PRESENT INVENTION

In order to comprehensively realize the safety analysis of severe accident in nuclear reactor and reveal some possible mechanistic phenomena in the process of severe accident, the present invention provides a method for analyzing severe accidents in nuclear reactors based on an advanced particle method on the basis of mechanistic analysis of key phenomena of severe accident in nuclear reactor, which is capable of analyzing mechanical structure changes, fluid motion, heat transfer phase change, chemical reactions and neutron physics during the severe accident in the nuclear reactor, and obtain key data such as stress state of core materials, material changes, flow field, temperature field and neutron flux density in the reactor during the severe accident. The present invention has the ability to analyze key phenomena of the severe accident in the nuclear reactor, comprising but not limited to: core heating transient, core melting, melt migration, debris bed behavior, core melt retention behavior, melt-concrete interaction, and melt-coolant interaction, which provides an important basis for the safety characterization of severe accidents in nuclear power plant reactors.

Accordingly, in order to accomplish the above object, the present invention provides:
a method for analyzing a sever accident in a nuclear reactor based on an advanced particle method, comprising steps of:
step 1: according to a nuclear reactor severe accident analysis calculation object, constructing a particle geometry model, wherein an initial state of each particle is determined by an actual calculation object; setting particle property parameters, enthalpies, velocities, positions and stress-strain states, and setting boundary conditions according to the actual calculation object, comprising pressure boundaries, temperature boundaries, heat flow boundaries, pressure gradient boundaries, velocity boundaries, load boundaries, symmetry boundaries and period boundaries;
wherein the particle geometry model, key parameters, the initial state and the boundary conditions of the nuclear reactor severe accident analysis calculation object are established in the step 1, thereby restoring a real state of an arbitrarily complex nuclear reactor severe accident analysis calculation object;
step 2: calculating material property changes for each particle with a nuclear reactor material property library, comprising densities, specific heat capacities, thermal conductivities, melting points, boiling points, latent heat of melting, latent heat of vaporization, thermal conductivities, Young's modulus, Poisson's ratios, thermal expansion coefficients and thermal creep coefficients; and updating the key parameters, comprising particle number densities, particle neighborhood sets and time steps required by the advanced particle method;
wherein the material properties and the key parameters of each particle is updated in the step 2; material property update is used to obtain changes in reactor type material properties during the severe accident in real time, and key parameter update ensures necessary conditions required for accuracy of the advanced particle method, which provide conditions and supports for subsequent nuclear reactor severe accident analysis calculations;
step 3: considering possible changes in mechanical structures during the severe accident in the nuclear reactor and performing mechanical structure calculations, comprising thermal expansion, elastic deformation, plastic deformation, creep and fracture calculations;
calculating a thermal expansion strain according to an equation (1):

$${[ d {s}^{T} ]}_{i} = {κ}_{i} ( {T}_{i} - {T}_{i}^{ref} ) ( \begin{matrix}1 & 0 & 0 \\ 0 & 1 & 0 \\ 0 & 0 & 1\end{matrix} ) \qquad equation ( 1 )$$

wherein
[ds^{T}]ᵢ is a thermal expansion stress increment tensor of a particle i, N/m²;
κᵢ is a thermal expansion coefficient of the particle i;
Tᵢ is a temperature of the particle i, K;
Tᵢ^{ref} is a reference temperature of the particle i, K;
calculating an elastic stress according to an equation (2):

σ_{αβ}^{E}=λε_{yy}^{E}δ_{αβ}+2με_{αβ}^{E} equation (2)
wherein
σ_{αβ}^{E} a component of an elastic stress tensor, N/m²;
λ is a first parameter of a Lamé constant,

$$λ = \frac{E υ}{( 1 + υ ) ( 1 - 2 υ )} ;$$

μ is a second parameter of the Lamé constant,

$$μ = \frac{E}{2 ( 1 + υ )} ;$$

wherein E is the Young's modulus and ν is the Poisson's ratio;
ε_{yy}^{E} is a sum of diagonal terms of the elastic strain tensor, ε_{yy}^{E}=ε₁₁^{E}+ε₂₂^{E}+ε₃₃^{E}; wherein ε₁₁^{E}, ε₂₂^{E}, ε₃₃^{E} are diagonal terms of first, second and third rows of the elastic strain tensor;
δ_{αβ} is a Kronecker function,

$${δ}_{α β} = \{ \begin{matrix}1 & α = β \\ 0 & α \neq β\end{matrix} ;$$

ε_{αβ}^{E} is a component of the elastic strain tensor;
α is α a direction, being any value in x, y, z;
β is a β direction, being any value in x, y, z;
if an equivalent force of the particle is greater than a yield limit, considering that the plastic deformation occurs, and calculating plastic stress-strain according to an equation (3) and an equation (4).

$${[ d {ε}^{p} ]}_{n} = {[ d ε ]}_{n} - [ d {ε}^{T} ] - \frac{{[ d ε ]}_{n} - {[ d {ε}^{T} ]}_{n} - {[ s ]}_{n - 1} d {λ}_{n}}{1 + 2 μ d {λ}_{n}} \qquad equation ( 3 )$$

$${[ d ε ]}_{n} = {[ d {ε}^{p} ]}_{n} + {[ d {ε}^{e} ]}_{n} + {[ d {ε}^{T} ]}_{n} \qquad equation ( 4 )$$

wherein
[dε^{P}]ⁿ is a plastic strain increment tensor at a time step n, N/m²;
[dε]ₙ is a strain increment tensor at the time step n, N/m²;
[dε^{T}]ₙ is a thermal expansion strain increment tensor at the time step n, N/m²;
[dε^{e}]ₙ is an elastic strain increment tensor at the time step n, N/m²;
[s]ₙ₋₁ is a strain tensor at a time step n−1, N/m²;
dλₙ is an incremental parameter, determined by material mechanical properties;
determining a creep calculation by a creep rate, and calculating according to an equation (5)

[symbol]

=ωσϕ equation (5)
wherein
[symbol] is the creep rate;
ω̅ is a thermal creep coefficient;
σ is a stress tensor, N/m²;
ϕ is a fast neutron flux density, neutron/m²/s;
wherein fracture is determined according to an inter-particle stress size and a particle spacing; when the inter-particle stress is greater than a fracture stress threshold or when the particle spacing is greater than a tensile fracture threshold or when the particle spacing is less than a compression fracture threshold, the fracture is considered to occur; there is no solid stress between fractured particles, and an interaction therebetween is transformed into a collision interaction;
wherein stress or strain of each particle under thermal expansion, elasticity, plasticity, creep and fracture is calculated in the step 3, and then the velocities, the positions and energy of the particle are calculated by mass conservation, energy conservation and momentum conservation equations; the three conservation equations are in a same form; a scattering term of the stress is calculated by the advanced particle method in a discrete form, and the advanced particle method in the discrete form is shown in equations (6) to (12):

$$D {ϕ}_{i} = {H}_{s} M {b}_{i} \qquad equation ( 6 )$$

$$D = {[ \frac{\partial }{\partial x} \frac{\partial }{\partial y} \frac{\partial }{\partial z} \frac{{\partial }^{2}}{\partial {x}^{2}} \frac{{\partial }^{2}}{\partial {y}^{2}} \frac{{\partial }^{2}}{\partial {z}^{2}} \frac{{\partial }^{2}}{\partial x \partial y} \frac{{\partial }^{2}}{\partial x \partial z} \frac{{\partial }^{2}}{\partial y \partial z} ]}^{T} \qquad equation ( 7 )$$

$${H}_{s} = diag ( \frac{i}{{n}^{0}} \frac{i}{{n}^{0}} \frac{i}{{n}^{0}} \frac{2}{{n}^{0} {l}_{0}} \frac{2}{{n}^{0} {l}_{0}} \frac{2}{{n}^{0} {l}_{0}} \frac{i}{{n}^{0} {l}_{0}} \frac{i}{{n}^{0} {l}_{0}} \frac{i}{{n}^{0} {l}_{0}} ) \qquad equation ( 8 )$$

$${M}^{- 1} = C = {\sum }_{j \neq i} \frac{{w}_{ij} {p}_{ij} ⊗ {p}_{ij}}{{n}^{0}} \qquad equation ( 9 )$$

$${b}_{i} = {\sum }_{j \neq i} {w}_{ij} {ϕ}_{ij} {p}_{ij} \qquad equation ( 10 )$$

$${p}_{ij} = \{ \begin{matrix}{[ \frac{{x}_{ij}}{{r}_{ij}} \frac{{y}_{ij}}{{r}_{ij}} \frac{{z}_{ij}}{{r}_{ij}} \frac{{x}_{ij}^{2}}{{l}_{0} {r}_{ij}} \frac{{y}_{ij}^{2}}{{l}_{0} {r}_{ij}} \frac{{z}_{ij}^{2}}{{l}_{0} {r}_{ij}} \frac{{x}_{ij} {y}_{ij}}{{l}_{0} {r}_{ij}} \frac{{x}_{ij} {z}_{ij}}{{l}_{0} {r}_{ij}} \frac{{y}_{ij} {z}_{ij}}{{l}_{0} {r}_{ij}} ]}^{T} & j ∈ Internal or Dirichlet \\ {[ {n}_{x} {n}_{y} {n}_{z} \frac{2 {n}_{x} {x}_{ij}}{{l}_{0}} \frac{2 {n}_{y} {y}_{ij}}{{l}_{0}} \frac{2 {n}_{z} {z}_{ij}}{{l}_{0}} \frac{{n}_{y} {x}_{ij} + {n}_{x} {y}_{ij}}{{l}_{0}} \frac{{n}_{z} {x}_{ij} + {n}_{x} {z}_{ij}}{{l}_{0}} \frac{{n}_{z} {y}_{ij} + {n}_{y} {z}_{ij}}{{l}_{0}} ]}^{T} & j ∈ Neumann\end{matrix} \qquad equation ( 11 )$$

$${ϕ}_{ij} = \{ \begin{matrix}\frac{{ϕ}_{j} - {ϕ}_{i}}{{r}_{ij}} & j ∈ Internal or Dirichlet \\ \frac{\partial {ϕ}_{j}}{\partial n} & j ∈ Neumann\end{matrix} \qquad equation ( 12 )$$

wherein
D is a second order differential operator as shown in the equation (7);
Hₛ is a coefficient diagonal matrix as shown in the equation (8);
M is a correction matrix as shown in the equation (9);
bᵢ is a correction parameter vector as shown in the equation (10);
M⁻¹ is an inverse matrix of the correction matrix M;
C is a coefficient matrix, which is same as the inverse matrix of the correction matrix M;
x is an x direction;
y is a y direction;
z is a z direction;
n⁰ is an initial particle number density;
l₀ is an initial particle spacing, m;
diag is diagonal matrix compliance;
wᵢⱼ is a kernel function value between the particle i and a particle j;
xᵢⱼ is a distance between the particle i and the particle j in the x direction, m;
yᵢⱼ is a distance between the particle i and the particle j in the y direction, m;
zᵢⱼ is a distance between the particle i and the particle j in the z direction, m;
rᵢⱼ a distance between the particle i and the particle j, m;
nₓ is a component of a normal vector of the particle j in the x direction;
n_{y} is a component of the normal vector of the particle j in the y direction;
n_{z} is a component of the normal vector of the particle j in the z direction;
ϕⱼ is an arbitrary parameter value of the particle j, which is a vector or a scalar;
ϕᵢ is an arbitrary parameter value of the particle i, which is a vector or a scalar;

$$\frac{\partial {ϕ}_{j}}{\partial n}$$

is a partial derivative of an arbitrary parameter of the particle j in a direction of the normal vector of the particle j;
Internal is an internal particle;
Dirichlet is is a fixed-value boundary condition, comprising the pressure boundaries, the temperature boundaries and the velocity boundaries;
Neumann is a gradient boundary condition, comprising the heat flow boundaries, the pressure gradient boundaries, and the load boundaries;
wherein macroscopic state changes in velocity, position and energy of the actual calculation object under the thermal expansion, the elasticity, the plasticity, the creep and the fracture are obtained;
step 4: performing a thermal hydraulic calculation, comprising fluid motions under gravity, viscous forces, pressure and surface tensions, and fluid energy changes during heat transfer;
calculating the fluid motions according to an equation (13), so as to obtain velocity and position changes of fluid particles;

$$ρ \frac{d u}{d t} = - ∇ P + {μ}_{f} {∇}^{2} u + ρ f + ρ g \qquad equation ( 13 )$$

wherein
t is time, s;
ρ is a density, kg/m³;
u is a velocity vector, m/s;
P is a pressure, Pa;
μ_{f} is a dynamic viscosity, Pa·s;
f is a surface tension vector, N/kg;
g is a gravitational acceleration vector, m/s²;
wherein a gradient term of the pressure and a velocity Laplace term of a viscosity term uses the advanced particle method in the discrete form as shown in the equations (6) to (12), and the pressure is calculated by implicit iterative solution of a pressure Poisson equation, as shown in an equation (14):

$$\frac{1}{ρ} {( {∇}^{2} {P}^{k + i} )}_{i} = \frac{1 - ξ}{Δ t} ∇ \cdot {u}^{*} - \frac{ξ}{Δ {t}^{2}} ( \frac{{n}^{*} - {n}^{0}}{{n}^{0}} ) \qquad equation ( 14 )$$

wherein
n* is a temporary particle number density, which is calculated from particle position obtained by calculating a gravity term, the viscosity term and a surface tension term for the particle;
ξ is a pressure Poisson's equation weighting coefficient, ranging from 0 to 1;
Δt is a time step, s;
u* is a temporary velocity vector, m/s;
P^{k+1} is a pressure value at a time step k+1, Pa;
∇is a Hamiltonian arithmetic;
wherein during a discretization process of the advanced particle method, a dynamic viscosity in the viscosity term adopts a harmonic average of the dynamic viscosity, as shown in an equation (15)

$${μ}_{ij} = \frac{2 {μ}_{i} {μ}_{j}}{{μ}_{i} + {μ}_{j}} \qquad Equation ( 15 )$$

wherein
μᵢⱼ is a dynamic viscosity between the particle i and the particle j, Pa·s;
μᵢ is a dynamic viscosity of the particle i, Pa·s;
μⱼ is a dynamic viscosity of the particle j, Pa·s;
calculating the surface tension with a free energy model based on a surface tension model, as shown in an equation (16)

f=F(rᵢⱼ−rₘᵢₙ)(rᵢⱼ−rₑ)/m equation (16)
wherein
f is a surface tension vector, N/kg;
m is a mass, kg;
F is a free energy coefficient;
rₘᵢₙ is a minimum distance of the particle i from surrounding particles, adopting 1.5 l₀;
rₑ is a particle radius of action;
wherein a fluid heat transfer process calculation comprises radiation, heat conduction, convection, heat flow boundaries and chemical heat as shown in an equation (17), from which energy changes of the fluid particles are calculated;

$$ρ \frac{\partial H}{\partial t} = {ρ ( \frac{\partial H}{\partial t} )}_{Trans} + {ρ ( \frac{\partial H}{\partial t} )}_{radiation} + {Q}_{heatflow} + {Q}_{chem} \qquad equation ( 17 )$$

wherein
H is an enthalpy, J/kg;
ρ is a density, kg/m³;
Q_{heatflow} is a volume heat flow boundary, W/m³;
Q_{chem} is chemical heat, W/m³;

$${( \frac{\partial H}{\partial t} )}_{Trans}$$

is a partial derivative of the enthalpy against time due to the heat conduction and convective heat exchange, W/kg;

$${( \frac{\partial H}{\partial t} )}_{radiation}$$

is a partial derivative of the enthalpy against time due to radiative heat exchange, W/kg;
wherein a partial derivative calculation of the enthalpy against time due to the heat conduction and the convective heat transfer uses a thermal conductivity differential equation, as shown in an equation (18); in the advanced particle method, the heat conduction and the convection use a same set of models; for the heat conduction, the particles do not move; and for the convection, the particles move; a temperature Laplace term in the equation (18) uses the advanced particle method in the discrete form as shown in the equations (6) to (12), the thermal conductivity during a discrete process adopts a harmonic average;

$${( \frac{\partial H}{\partial t} )}_{Trans} = \frac{k}{ρ} {∇}^{2} T \qquad equation ( 18 )$$

wherein
k is the thermal conductivity, W/(m·K);
T is the temperature, K;
calculating the radiative heat exchange according to an equation (19):

$${( \frac{\partial H}{\partial t} )}_{radiation} = \frac{{εσ}_{s} ( {T}_{i}^{4} - {T}_{j}^{4} )}{ρ {l}_{0}} \qquad equation ( 19 )$$

wherein
ε is an emissivity;
σₛ is a Stefan-Boltzmann constant;
Tᵢ is the temperature of the particle i, K;
Tⱼ is a temperature of the particle j, K;
determining the heat flow boundaries according to an actual situation, comprising heat source and the cooling boundaries;
determining the chemical heat by chemical reactions;
wherein changes of fluid particle velocities, positions and energy are calculated in the step 4, which truly reflect fluid motion and temperature field changes of the calculation object during the serious accident in an actual nuclear reactor;
step 5: performing a chemical reaction calculation, comprising redox reactions, eutectic reactions and corrosion phenomena, wherein the redox reactions determine a material change rate based on a reaction rate, the eutectic reactions are determined based on a diffusion rate, and the corrosion phenomena are determined by a corrosion rate; the chemical reaction calculation relays on a nuclear reactor material database;
wherein the step 5 calculates the material component changes of a core material under the chemical reactions, and truly reflects chemical reaction effects on the severe accident in the nuclear reactor through the material property changes;
step 6: performing a neutron physics calculation using a multigroup approximation S_{N} difference Boltzmann transport equation as shown in an equation (20)

$$Ω \cdot ∇ ϕ ( r , Ω , {E}_{n} ) + {\sum }_{t} ϕ ( r , Ω , {E}_{n} ) = \int \int {\sum }_{s} ( r , {Ω}^{′} , {E}_{n}^{′} \to Ω , {E}_{n} ) ϕ ( r , {Ω}^{′} , {E}_{n}^{′} ) d {Ω}^{′} {dE}_{n}^{′} + \frac{χ ( r , {E}_{n} )}{4 π} \int \int v {\sum }_{f} ( r , {Ω}^{′} , {E}_{n}^{′} ) ϕ ( r , {Ω}^{′} , {E}_{n}^{′} ) d {Ω}^{′} {dE}_{n}^{′} + \frac{Q ( r , {E}_{n} )}{4 π} \qquad equation ( 20 )$$

wherein
Ω is a direction vector;
Ω′ is another direction vector, but different from Ω;
ϕ(r,Ω,Eₙ) is a neutron angular flux density when an input is r,Ω,Eₙ;
ϕ(r,Ω′,E′ₙ) is a neutron angular flux density when the input is r,Ω′,E′ₙ;
Σₜ is a total neutron cross section;
Q(r,Eₙ) is neutron source intensity;
Eₙ is neutron energy;
E′ₙ is another neutron energy, but different from Eₙ;
Σₛ(r,Ω′,E′ₙ→Ω,Eₙ) is a scattering cross section;
χ(r,Eₙ) is a fission spectrum;
ν is a quantity of neutrons released per fission;
Σ_{f}(r,Ω′,E′ₙ) is a neutron fission cross section;
selecting a multi-group core cross-section database according to an actual calculation reactor type; arranging a structured grid on a core particle geometry arrangement, and adopting a coarse mesh finite difference method to accelerate solution; using a particle mesh mapping technology to realize grid-particle information interaction;
wherein the step 6 calculates the neutron angular flux density in the core, and changes a heat source distribution in the core through the neutron angular flux density to change the material physical properties and material stress strain, thus realizing coupling analysis of neutron physics and thermal engineering hydraulics; and
step 7: outputting required data; determining whether an end-of-calculation condition is met, if not, advancing the time step and returning to the step 2, if yes, ending calculation;
wherein the steps 1-7 are used to analyze the severe accident in the nuclear reactor, which integrate possible key factors during the severe accident in the nuclear reactor, comprising the mechanical structure changes, the fluid motions, heat transfer phase changes, the chemical reactions and the neutron physics, so as to analyze key phenomena of the severe accident in the nuclear reactor, mainly comprising: core heating transients, core melting, melt migration, debris bed behavior, core melt retention behavior, melt-concrete interaction, and melt-coolant interaction.

The present invention is based on the discrete form of the advanced particle method for accurately capturing cross-sectional changes, matter changes, and phase changes.

The present invention is based on the discrete form of the advanced particle method to effectively avoid a mesh distortion problem existing in a large deformation.

The method of the present invention provides solutions for the analysis of the severe accidents in the nuclear reactors and provides an important basis for the safety characterization of the severe accidents in nuclear power plant reactors.

Compared with the prior art, the method of the present invention has the following advantages:

The method for analyzing the sever accident in the nuclear reactor based on the advanced particle method of the present invention integrates possible key factors during the severe accident in the nuclear reactor, comprising the mechanical structure changes, the fluid motions, heat transfer phase changes, the chemical reactions and the neutron physics, so as to analyze key phenomena of the severe accident in the nuclear reactor, mainly comprising: core heating transients, core melting, melt migration, debris bed behavior, core melt retention behavior, melt-concrete interaction, and melt-coolant interaction. The method of the present invention is based on the discrete form of the advanced particle method, which has higher accuracy compared with the conventional particle method, and is capable of accurately capturing cross-sectional changes, matter changes, and phase changes. Compared with a grid method, the present invention can effectively avoid a mesh distortion problem existing in a large deformation. The algorithm process is easy to realize massively parallel computation. In summary, the method can be more comprehensive, effective and efficient for the safety analysis of the severe accident in the nuclear reactor.

### BRIEF DESCRIPTION OF THE DRAWINGS

FIGURE is a flow chart of a method for analyzing a sever accident in a nuclear reactor based on an advanced particle method according to the present invention.

### DETAILED DESCRIPTION OF THE PREFERRED EMBODIMENT

Referring to the accompanying drawing and embodiment, the present invention will be further illustrated.

The present invention provides a method for analyzing a sever accident in a nuclear reactor based on an advanced particle method, as shown in FIGURE. High-temperature melting process analysis of a single fuel rod in a typical pressurized water reactor under simplified conditions is taken as an example, comprising steps of:
step 1: according to a single fuel rod in a typical pressurized water reactor, constructing a particle geometry model, wherein a simplified fuel rod considers only a UO₂ core block and a Zr-4 alloy cladding; the fuel rod in a bare state with no additional stress strain; the core block is set as an internal heat source, a size of which is calculated based on a decay power;
step 2: calculating material property changes for the UO₂ core block and the Zr-4 alloy cladding with a nuclear reactor material property library, comprising densities, specific heat capacities, thermal conductivities, melting points, boiling points, latent heat of melting, latent heat of vaporization, thermal conductivities, Young's modulus, Poisson's ratios, thermal expansion coefficients and thermal creep coefficients; and updating the key parameters, comprising particle number densities, particle neighborhood sets and time steps required by the advanced particle method;
step 3: considering possible changes in mechanical structures during the severe accident in the nuclear reactor and performing mechanical structure calculations, comprising thermal expansion, elastic deformation, plastic deformation, creep and fracture calculations;
calculating a thermal expansion strain according to an equation (1):

$${[ d {s}^{T} ]}_{i} = {κ}_{i} ( {T}_{i} - {T}_{i}^{r e f} ) ( \begin{matrix}1 & 0 & 0 \\ 0 & 1 & 0 \\ 0 & 0 & 1\end{matrix} ) \qquad equation ( 1 )$$

wherein
[ds^{T}]ᵢ is a thermal expansion stress increment tensor of a particle i, N/m²;
κᵢ is a thermal expansion coefficient of the particle i;
Tᵢ is a temperature of the particle i, K;
Tᵢ^{ref} is a reference temperature of the particle i, K;
calculating an elastic stress according to an equation (2):

σ_{αβ}^{E}=λε_{yy}^{E}δ_{αβ}+2με_{αβ}^{E} equation (2)
wherein
σ_{αβ}^{E} a component of an elastic stress tensor, N/m²;
λ is a first parameter of a Lamé constant,

$$λ = \frac{E υ}{( 1 + υ ) ( 1 - 2 υ )} ;$$

μ is a second parameter of the Lamé constant,

$$μ = \frac{E}{2 ( 1 + υ )} ;$$

wherein E is the Young's modulus and ν is the Poisson's ratio;
ε_{yy}^{E} is a sum of diagonal terms of the elastic strain tensor, ε_{yy}^{E}=ε₁₁^{E}+ε₂₂^{E}+ε₃₃^{E}; wherein ε₁₁^{E}, ε₂₂^{E}, ε₃₃^{E} are diagonal terms of first, second and third rows of the elastic strain tensor;
δ_{αβ} is a Kronecker function,

$${δ}_{α β} = \{ \begin{matrix}1 & α = β \\ 0 & α \neq β\end{matrix} ;$$

ε_{αβ}^{E} is a component of the elastic strain tensor;
α is α a direction, being any value in x, y, z;
β is a β direction, being any value in x, y, z;
if an equivalent force of the particle is greater than a yield limit, considering that the plastic deformation occurs, and calculating plastic stress-strain according to an equation (3) and an equation (4).

$${[ d {ε}^{p} ]}_{n} = {[ d ε ]}_{n} - {[ d {ε}^{T} ]}_{n} - \frac{{[ d ε ]}_{n} - {[ d {ε}^{T} ]}_{n} - {[ s ]}_{n - 1} d {λ}_{n}}{1 + 2 μ d {λ}_{n}} \qquad equation ( 3 )$$

$$[ d ε ] = {[ d {ε}^{p} ]}_{n} + {[ d {ε}^{e} ]}_{n} + {[ d {ε}^{T} ]}_{n} \qquad equation ( 4 )$$

wherein
[dε^{P}]ⁿ is a plastic strain increment tensor at a time step n, N/m²;
[dε]ₙ is a strain increment tensor at the time step n, N/m²;
[dε^{T}]ₙ is a thermal expansion strain increment tensor at the time step n, N/m²;
[dε^{e}]ₙ is an elastic strain increment tensor at the time step n, N/m²;
[s]ₙ₋₁ is a strain tensor at a time step n−1, N/m²;
μ is a second parameter of the Lamé constant,

$$μ = \frac{E}{2 ( 1 + υ )} ;$$

dλₙ is an incremental parameter, determined by material mechanical properties;
determining a creep calculation by a creep rate, and calculating according to an equation (5)

[symbol]

=ωσϕ equation (5)
wherein
[symbol] is the creep rate;
ω̅ is a thermal creep coefficient;
σ is a stress tensor, N/m²;
ϕ is a fast neutron flux density, neutron/m²/s;
wherein fracture is determined according to an inter-particle stress size and a particle spacing; when the inter-particle stress is greater than a fracture stress threshold or when the particle spacing is greater than a tensile fracture threshold or when the particle spacing is less than a compression fracture threshold, the fracture is considered to occur; there is no solid stress between fractured particles, and an interaction therebetween is transformed into a collision interaction;
wherein stress or strain of each particle under thermal expansion, elasticity, plasticity, creep and fracture is calculated in the step 3, and then the velocities, the positions and energy of the particle are calculated by mass conservation, energy conservation and momentum conservation equations; the three conservation equations are common and in the same form, which will not be listed here; a scattering term of the stress is calculated by the advanced particle method in a discrete form, and the advanced particle method in the discrete form is shown in equations (6) to (12):

$$D {ϕ}_{i} = {H}_{s} {Mb}_{i} \qquad equation ( 6 )$$

$$D = [ \begin{matrix}\begin{matrix}\begin{matrix}\begin{matrix}\begin{matrix}\begin{matrix}\begin{matrix}\begin{matrix}\frac{\partial }{\partial x} & \frac{\partial }{\partial y}\end{matrix} & \frac{\partial }{\partial z}\end{matrix} & \frac{{\partial }^{2}}{\partial {x}^{2}}\end{matrix} & \frac{{\partial }^{2}}{\partial {y}^{2}}\end{matrix} & \frac{{\partial }^{2}}{\partial {z}^{2}}\end{matrix} & \frac{{\partial }^{2}}{\partial x \partial y}\end{matrix} & \frac{{\partial }^{2}}{\partial x \partial z}\end{matrix} & {\frac{{\partial }^{2}}{\partial y \partial z} ]}^{T}\end{matrix} \qquad equation ( 7 )$$

$${H}_{s} = diag ( \begin{matrix}\begin{matrix}\begin{matrix}\begin{matrix}\begin{matrix}\begin{matrix}\begin{matrix}\begin{matrix}\frac{1}{{n}^{0}} & \frac{1}{{n}^{0}}\end{matrix} & \frac{1}{{n}^{0}}\end{matrix} & \frac{2}{{n}^{0} {l}_{0}}\end{matrix} & \frac{2}{{n}^{0} {l}_{0}}\end{matrix} & \frac{2}{{n}^{0} {l}_{0}}\end{matrix} & \frac{1}{{n}^{0} {l}_{0}}\end{matrix} & \frac{1}{{n}^{0} {l}_{0}}\end{matrix} & \frac{1}{{n}^{0} {l}_{0}}\end{matrix} ) \qquad equation ( 8 )$$

$${M}^{- 1} = C = {\sum }_{j \neq i} \frac{{w}_{ij} {p}_{ij} ⊗ {p}_{ij}}{{n}^{0}} \qquad equation ( 9 )$$

$${b}_{i} = {\sum }_{j \neq i} {w}_{ij} {ϕ}_{ij} {p}_{ij} \qquad equation ( 10 )$$

$${p}_{ij} = \{ \begin{matrix}[ \begin{matrix}\begin{matrix}\begin{matrix}\begin{matrix}\begin{matrix}\begin{matrix}\begin{matrix}\frac{{x}_{ij}}{{r}_{ij}} & \frac{{y}_{ij}}{{r}_{ij}}\end{matrix} & \frac{{z}_{ij}}{{r}_{ij}}\end{matrix} & \frac{{x}_{ij}^{2}}{{l}_{0} {r}_{ij}}\end{matrix} & \frac{{y}_{ij}^{2}}{{l}_{0} {r}_{ij}}\end{matrix} & \frac{{z}_{ij}^{2}}{{l}_{0} {r}_{ij}}\end{matrix} & \frac{{x}_{ij} {y}_{ij}}{{l}_{0} {r}_{ij}}\end{matrix} & \frac{{x}_{ij} {z}_{ij}}{{l}_{0} {r}_{ij}} & {\frac{{y}_{ij} {z}_{ij}}{{l}_{0} {r}_{ij}} ]}^{T}\end{matrix} & j ∈ Internal or Dirichlet \\ [ \begin{matrix}\begin{matrix}\begin{matrix}\begin{matrix}\begin{matrix}\begin{matrix}\begin{matrix}\begin{matrix}{n}_{x} & {n}_{y}\end{matrix} & {n}_{z}\end{matrix} & \frac{2 {n}_{x} {x}_{ij}}{{l}_{0}}\end{matrix} & \frac{2 {n}_{y} {y}_{ij}}{{l}_{0}}\end{matrix} & \frac{2 {n}_{z} {z}_{ij}}{{l}_{0}}\end{matrix} & \frac{\begin{matrix}{n}_{y} {x}_{ij} + \\ {n}_{x} {y}_{ij}\end{matrix}}{{l}_{0}}\end{matrix} & \frac{\begin{matrix}{n}_{z} {x}_{ij} + \\ {n}_{x} {z}_{ij}\end{matrix}}{{l}_{0}}\end{matrix} & \frac{\begin{matrix}{n}_{z} {x}_{ij} + \\ {n}_{x} {z}_{ij}\end{matrix}}{{l}_{0}}\end{matrix} ] & j ∈ Neumann\end{matrix} \qquad equation ( 11 )$$

$${ϕ}_{ij} = \{ \begin{matrix}\frac{{ϕ}_{j} - {ϕ}_{i}}{{r}_{ij}} & j ∈ Internal or dirichlet \\ \frac{\partial {ϕ}_{j}}{\partial n} & j ∈ Neumann\end{matrix} \qquad equation ( 12 )$$

wherein
D is a second order differential operator as shown in the equation (7);
Hₛ is a coefficient diagonal matrix as shown in the equation (8);
M is a correction matrix as shown in the equation (9);
bᵢ is a correction parameter vector as shown in the equation (10);
M⁻¹ is an inverse matrix of the correction matrix M;
C is a coefficient matrix, which is same as the inverse matrix of the correction matrix M;
x is an x direction;
y is a y direction;
z is a z direction;
n⁰ is an initial particle number density;
l₀ is an initial particle spacing, m;
diag is diagonal matrix compliance;
wᵢⱼ is a kernel function value between the particle i and a particle j;
xᵢⱼ is a distance between the particle i and the particle j in the x direction, m;
yᵢⱼ is a distance between the particle i and the particle j in the y direction, m;
zᵢⱼ is a distance between the particle i and the particle j in the z direction, m;
rᵢⱼ a distance between the particle i and the particle j, m;
nₓ is a component of a normal vector of the particle j in the x direction;
n_{y} is a component of the normal vector of the particle j in the y direction;
n_{z} is a component of the normal vector of the particle j in the z direction;
ϕⱼ is an arbitrary parameter value of the particle j, which is a vector or a scalar;
ϕᵢ is an arbitrary parameter value of the particle i, which is a vector or a scalar;

$$\frac{\partial {ϕ}_{j}}{\partial n}$$

is a partial derivative of an arbitrary parameter of the particle j in a direction of the normal vector of the particle j;
Internal is an internal particle;
Dirichlet is is a fixed-value boundary condition, comprising the pressure boundaries, the temperature boundaries and the velocity boundaries;
Neumann is a gradient boundary condition, comprising the heat flow boundaries, the pressure gradient boundaries, and the load boundaries;
wherein macroscopic state changes in velocity, position and energy of the actual calculation object under the thermal expansion, the elasticity, the plasticity, the creep and the fracture are obtained;
step 4: performing a thermal hydraulic calculation, comprising fluid motions under gravity, viscous forces, pressure and surface tensions, and fluid energy changes during heat transfer;
calculating the fluid motions according to an equation (13), so as to obtain velocity and position changes of fluid particles;

$$ρ \frac{d u}{d t} = - ∇ P + {μ}_{f} {∇}^{2} u + ρ f + ρ g \qquad equation ( 13 )$$

wherein
t is time, s;
ρ is a density, kg/m³;
u is a velocity vector, m/s;
P is a pressure, Pa;
μ_{f} is a dynamic viscosity, Pa·s;
f is a surface tension vector, N/kg;
g is a gravitational acceleration vector, m/s²;
wherein a gradient term of the pressure and a velocity Laplace term of a viscosity term uses the advanced particle method in the discrete form as shown in the equations (6) to (12), and the pressure is calculated by implicit iterative solution of a pressure Poisson equation, as shown in an equation (14):

$$\frac{1}{ρ} {( {∇}^{2} {P}^{k + 1} )}_{i} = \frac{1 - ξ}{Δ t} ∇ \cdot {u}^{*} - \frac{ξ}{Δ {t}^{2}} ( \frac{{n}^{*} - {n}^{0}}{{n}^{0}} ) \qquad equation ( 14 )$$

wherein
n is a temporary particle number density, which is calculated from particle position obtained by calculating a gravity term, the viscosity term and a surface tension term for the particle;
ξ is a pressure Poisson's equation weighting coefficient, ranging from 0 to 1;
Δt is a time step, s;
u* is a temporary velocity vector, m/s;
P^{k+1} is a pressure value at a time step k+1, Pa;
∇is a Hamiltonian arithmetic;
wherein during a discretization process of the advanced particle method, a dynamic viscosity in the viscosity term adopts a harmonic average of the dynamic viscosity, as shown in an equation (15)

$${μ}_{ij} = \frac{2 {μ}_{i} {μ}_{j}}{{μ}_{i} + {μ}_{j}} \qquad Equation ( 15 )$$

wherein
μᵢⱼ is a dynamic viscosity between the particle i and the particle j, Pa·s;
μᵢ is a dynamic viscosity of the particle i, Pa·s;
μⱼ is a dynamic viscosity of the particle j, Pa·s;
calculating the surface tension with a free energy model based on a surface tension model, as shown in an equation (16)

f=F(rᵢⱼ−rₘᵢₙ)(rᵢⱼ−rₑ)/m equation (16)
wherein
f is a surface tension vector, N/kg;
m is amass, kg;
F is a free energy coefficient;
rₘᵢₙ is a minimum distance of the particle i from surrounding particles, adopting 1.5 l₀;
rₑ is a particle radius of action;
wherein a fluid heat transfer process calculation comprises radiation, heat conduction, convection, heat flow boundaries and chemical heat as shown in an equation (17), from which energy changes of the fluid particles are calculated;

$$ρ \frac{\partial H}{\partial t} = {ρ ( \frac{\partial H}{\partial t} )}_{Trans} + {ρ ( \frac{\partial H}{\partial t} )}_{radiation} + {Q}_{heatflow} + {Q}_{chem} \qquad equation ( 17 )$$

wherein
H is an enthalpy, J/kg;
t is time, s;
ρ is a density, kg/m³;
Q_{heatflow} is a volume heat flow boundary, W/m³;
Q_{chem} is chemical heat, W/m³;

$${( \frac{\partial H}{\partial t} )}_{Trans}$$

is a partial derivative of the enthalpy against time due to the heat conduction and convective heat exchange, W/kg;

$${( \frac{\partial H}{\partial t} )}_{radiation}$$

is a partial derivative of the enthalpy against time due to radiative heat exchange, W/kg;
wherein a partial derivative calculation of the enthalpy against time due to the heat conduction and the convective heat transfer uses a thermal conductivity differential equation, as shown in an equation (18); in the advanced particle method, the heat conduction and the convection use a same set of models; for the heat conduction, the particles do not move; and for the convection, the particles move; a temperature Laplace term in the equation (18) uses the advanced particle method in the discrete form as shown in the equations (6) to (12), the thermal conductivity during a discrete process adopts a harmonic average;

$${( \frac{\partial H}{\partial t} )}_{Trans} = \frac{k}{ρ} {∇}^{2} T \qquad equation ( 18 )$$

wherein
k is the thermal conductivity, W/(m·K);
T is the temperature, K;
calculating the radiative heat exchange according to an equation (19):

$${( \frac{\partial H}{\partial t} )}_{radiation} = \frac{{εσ}_{s} ( {T}_{i}^{4} - {T}_{j}^{4} )}{ρ {l}_{0}} \qquad equation ( 19 )$$

wherein
ε is an emissivity;
σₛ is a Stefan-Boltzmann constant;
Tᵢ is the temperature of the particle i, K;
Tⱼ is a temperature of the particle j, K;
determining the heat flow boundaries according to an actual situation, comprising heat source and the cooling boundaries;
determining the chemical heat by chemical reactions;
wherein changes of fluid particle velocities, positions and energy are calculated in the step 4, which truly reflect fluid motion and temperature field changes of the calculation object during the serious accident in an actual nuclear reactor;
step 5: performing a chemical reaction calculation, wherein the embodiment only takes eutectic reactions between the UO₂ core block and the Zr-4 alloy cladding into account;
wherein the step 5 calculates the material component changes of a core material under the eutectic reactions which may lead to premature melting of the core block;
step 6: performing a neutron physics calculation using a multigroup approximation S_{N} difference Boltzmann transport equation as shown in an equation (20)

$$Ω \cdot ∇ ϕ ( r , Ω , {E}_{n} ) + {Σ}_{t} ϕ ( r , Ω , {E}_{n} ) = \int \int {Σ}_{s} ( r , {Ω}^{′} , {E}_{n}^{′} \to Ω , {E}_{n} ) ϕ ( r , {Ω}^{′} , {E}_{n}^{′} ) d {Ω}^{′} {dE}_{n}^{′} + \frac{χ ( r , {E}_{n} )}{4 π} \int \int v {Σ}_{f} ( r , {Ω}^{′} , {E}_{n}^{′} ) ϕ ( r , {Ω}^{′} , {E}_{n}^{′} ) d {Ω}^{′} {dE}_{n}^{′} + \frac{Q ( r , {E}_{n} )}{4 π} \qquad equation ( 20 )$$

wherein
Ω is a direction vector;
Ω′ is another direction vector, but different from Ω;
ϕ(r,Ω,Eₙ) is a neutron angular flux density when an input is r,Ω,Eₙ;
ϕ(r,Ω′,E′ₙ) is a neutron angular flux density when the input is r,Ω′,E′ₙ;
Σₜ is a total neutron cross section;
Q(r,Eₙ) is neutron source intensity;
Eₙ is neutron energy;
E′ₙ is another neutron energy, but different from Eₙ;
Σₛ(r,Ω′,E′ₙ→Ω,Eₙ) is a scattering cross section;
χ(r,Eₙ) is a fission spectrum;
ν is a quantity of neutrons released per fission;
Σ_{f}(r,Ω′,E′ₙ) is a neutron fission cross section;
selecting a pressurized water reactor multi-group core cross-section database to calculate the core cross section; arranging a structured grid on a core particle geometry arrangement, and adopting a coarse mesh finite difference method to accelerate solution; using a particle mesh mapping technology to realize grid-particle information interaction;
wherein the step 6 calculates the neutron angular flux density in the core, and changes an internal heat source power of the core block through the neutron angular flux density; and
step 7: outputting required data; determining whether an end-of-calculation condition is met, if not, advancing the time step and returning to the step 2, if yes, ending calculation.

What is claimed is:

1. A method for analyzing a sever accident in a nuclear reactor based on an advanced particle method, comprising steps of:
step 1: according to a nuclear reactor severe accident analysis calculation object, constructing a particle geometry model, wherein an initial state of each particle is determined by an actual calculation object; setting particle property parameters, enthalpies, velocities, positions and stress-strain states, and setting boundary conditions according to the actual calculation object, comprising pressure boundaries, temperature boundaries, heat flow boundaries, pressure gradient boundaries, velocity boundaries, load boundaries, symmetry boundaries and period boundaries;
wherein the particle geometry model, key parameters, the initial state and the boundary conditions of the nuclear reactor severe accident analysis calculation object are established in the step 1, thereby restoring a real state of an arbitrarily complex nuclear reactor severe accident analysis calculation object;
step 2: calculating material property changes for each particle with a nuclear reactor material property library, comprising densities, specific heat capacities, thermal conductivities, melting points, boiling points, latent heat of melting, latent heat of vaporization, thermal conductivities, Young's modulus, Poisson's ratios, thermal expansion coefficients and thermal creep coefficients; and updating the key parameters, comprising particle number densities, particle neighborhood sets and time steps required by the advanced particle method;
wherein the material properties and the key parameters of each particle is updated in the step 2; material property update is used to obtain changes in reactor type material properties during the severe accident in real time, and key parameter update ensures necessary conditions required for accuracy of the advanced particle method, which provide conditions and supports for subsequent nuclear reactor severe accident analysis calculations;
step 3: considering possible changes in mechanical structures during the severe accident in the nuclear reactor and performing mechanical structure calculations, comprising thermal expansion, elastic deformation, plastic deformation, creep and fracture calculations;
calculating a thermal expansion strain according to an equation (1):
$${[ d {s}^{T} ]}_{i} = {κ}_{i} ( {T}_{i} - {T}_{i}^{ref} ) ( \begin{matrix}1 & 0 & 0 \\ 0 & 1 & 0 \\ 0 & 0 & 1\end{matrix} ) \qquad equation ( 1 )$$
wherein
[ds^{T}]ᵢ is a thermal expansion stress increment tensor of a particle i, N/m²;
κᵢ is a thermal expansion coefficient of the particle i;
Tᵢ is a temperature of the particle i, K;
Tᵢ^{ref} is a reference temperature of the particle i, K;
calculating an elastic stress according to an equation (2):
σ_{αβ}^{E}=λε_{yy}^{E}δ_{αβ}+2με_{αβ}^{E} equation (2)
wherein
σ_{αβ}^{E} a component of an elastic stress tensor, N/m²;
λ is a first parameter of a Lamé constant,
$$λ = \frac{E υ}{( 1 + υ ) ( 1 - 2 υ )} ;$$
μ is a second parameter of the Lamé constant,
$$μ = \frac{E}{2 ( 1 + υ )} ;$$
wherein E is the Young's modulus and ν is the Poisson's ratio;
ε_{yy}^{E} is a sum of diagonal terms of the elastic strain tensor, ε_{yy}^{E}=ε₁₁^{E}+ε₂₂^{E}+ε₃₃^{E}; wherein ε₁₁^{E}, ε₂₂^{E}, ε₃₃^{E} are diagonal terms of first, second and third rows of the elastic strain tensor;
δ_{αβ} is a Kronecker function,
$${δ}_{α β} = \{ \begin{matrix}1 & α = β \\ 0 & α \neq β\end{matrix} ;$$
ε_{αβ}^{E} is a component of the elastic strain tensor;
α is α a direction, being any value in x, y, z;
β is a β direction, being any value in x, y, z;
if an equivalent force of the particle is greater than a yield limit, considering that the plastic deformation occurs, and calculating plastic stress-strain according to an equation (3) and an equation (4).
$${[ d {ε}^{p} ]}_{n} = {[ d ε ]}_{n} - {[ d {ε}^{T} ]}_{n} - \frac{{[ d ε ]}_{n} - {[ d {ε}^{T} ]}_{n} - {[ s ]}_{n - 1} d {λ}_{n}}{1 + 2 μ d {λ}_{n}} \qquad equation ( 3 )$$
$${[ d ε ]}_{n} = {[ d {ε}^{p} ]}_{n} + {[ d {ε}^{e} ]}_{n} + {[ d {ε}^{T} ]}_{n} \qquad equation ( 4 )$$
wherein
[dε^{P}]ⁿ is a plastic strain increment tensor at a time step n, N/m²;
[dε]ₙ is a strain increment tensor at the time step n, N/m²;
[dε^{T}]ₙ is a thermal expansion strain increment tensor at the time step n, N/m²;
[dε^{e}]ₙ is an elastic strain increment tensor at the time step n, N/m²;
[s]ₙ₋₁ is a strain tensor at a time step n−1, N/m²;
dλₙ is an incremental parameter, determined by material mechanical properties;
determining a creep calculation by a creep rate, and calculating according to an equation (5) [symbol]
=ωσϕ equation (5)
wherein [symbol]
is the creep rate;
ω̅ is a thermal creep coefficient;
σ is a stress tensor, N/m²;
ϕ is a fast neutron flux density, neutron/m²/s;
wherein fracture is determined according to an inter-particle stress size and a particle spacing; when the inter-particle stress is greater than a fracture stress threshold or when the particle spacing is greater than a tensile fracture threshold or when the particle spacing is less than a compression fracture threshold, the fracture is considered to occur; there is no solid stress between fractured particles, and an interaction therebetween is transformed into a collision interaction;
wherein stress or strain of each particle under thermal expansion, elasticity, plasticity, creep and fracture is calculated in the step 3, and then the velocities, the positions and energy of the particle are calculated by mass conservation, energy conservation and momentum conservation equations; the three conservation equations are in a same form; a scattering term of the stress is calculated by the advanced particle method in a discrete form, and the advanced particle method in the discrete form is shown in equations (6) to (12):
$$D {ϕ}_{i} = {H}_{s} M {b}_{i} \qquad equation ( 6 )$$
$$D = {[ \frac{\partial }{\partial x} \frac{\partial }{\partial y} \frac{\partial }{\partial z} \frac{{\partial }^{2}}{\partial {x}^{2}} \frac{{\partial }^{2}}{\partial {y}^{2}} \frac{{\partial }^{2}}{\partial {z}^{2}} \frac{{\partial }^{2}}{\partial x \partial y} \frac{{\partial }^{2}}{\partial x \partial z} \frac{{\partial }^{2}}{\partial y \partial z} ]}^{T} \qquad equation ( 7 )$$
$${H}_{s} = diag ( \frac{1}{{n}^{0}} \frac{1}{{n}^{0}} \frac{1}{{n}^{0}} \frac{2}{{n}^{0} {l}_{0}} \frac{2}{{n}^{0} {l}_{0}} \frac{2}{{n}^{0} {l}_{0}} \frac{1}{{n}^{0} {l}_{0}} \frac{1}{{n}^{0} {l}_{0}} \frac{1}{{n}^{0} {l}_{0}} ) \qquad equation ( 8 )$$
$${M}^{- 1} = C = {\sum }_{j \neq i} \frac{{w}_{ij} {p}_{ij} ⊗ {p}_{ij}}{{n}^{0}} \qquad equation ( 9 )$$
$${b}_{i} = {\sum }_{j \neq i} {w}_{ij} {ϕ}_{ij} {p}_{ij} \qquad equation ( 10 )$$
$${p}_{ij} = \{ \begin{matrix}{[ \frac{{x}_{ij}}{{r}_{ij}} \frac{{y}_{ij}}{{r}_{ij}} \frac{{z}_{ij}}{{r}_{ij}} \frac{{x}_{ij}^{2}}{{l}_{0} {r}_{ij}} \frac{{y}_{ij}^{2}}{{l}_{0} {r}_{ij}} \frac{{z}_{ij}^{2}}{{l}_{0} {r}_{ij}} \frac{{x}_{ij} {y}_{ij}}{{l}_{0} {r}_{ij}} \frac{{x}_{ij} {z}_{ij}}{{l}_{0} {r}_{ij}} \frac{{y}_{ij} {z}_{ij}}{{l}_{0} {r}_{ij}} ]}^{T} & j ∈ Internal or Dirichlet \\ {[ {n}_{x} {n}_{y} {n}_{z} \frac{2 {n}_{x} {x}_{ij}}{{l}_{0}} \frac{2 {n}_{y} {y}_{ij}}{{l}_{0}} \frac{2 {n}_{z} {z}_{ij}}{{l}_{0}} \frac{( {n}_{y} {x}_{ij} + {n}_{x} {y}_{ij} )}{( {l}_{0} )} \frac{( {n}_{z} {x}_{ij} + {n}_{x} {z}_{ij} )}{( {l}_{0} )} \frac{( {n}_{z} {y}_{ij} + {n}_{y} {z}_{ij} )}{( {l}_{0} )} ]}^{T} & j ∈ Neumann\end{matrix} \qquad equation ( 11 )$$
$${ϕ}_{ij} = \{ \begin{matrix}\frac{{ϕ}_{j} - {ϕ}_{i}}{{r}_{ij}} & j ∈ Internal or Dirichlet \\ \frac{\partial {ϕ}_{j}}{\partial n} & j ∈ Neumann\end{matrix} \qquad equation ( 12 )$$
wherein
D is a second order differential operator as shown in the equation (7);
Hₛ is a coefficient diagonal matrix as shown in the equation (8);
M is a correction matrix as shown in the equation (9);
bᵢ is a correction parameter vector as shown in the equation (10);
M⁻¹ is an inverse matrix of the correction matrix M;
C is a coefficient matrix, which is same as the inverse matrix of the correction matrix M;
x is an x direction;
y is a y direction;
z is a z direction;
n⁰ is an initial particle number density;
l₀ is an initial particle spacing, m;
diag is diagonal matrix compliance;
wᵢⱼ is a kernel function value between the particle i and a particle j;
xᵢⱼ is a distance between the particle i and the particle j in the x direction, m;
yᵢⱼ is a distance between the particle i and the particle j in the y direction, m;
zᵢⱼ is a distance between the particle i and the particle j in the z direction, m;
rᵢⱼ a distance between the particle i and the particle j, m;
nₓ is a component of a normal vector of the particle j in the x direction;
n_{y} is a component of the normal vector of the particle j in the y direction;
n_{z} is a component of the normal vector of the particle j in the z direction;
ϕⱼ is an arbitrary parameter value of the particle j, which is a vector or a scalar;
ϕᵢ is an arbitrary parameter value of the particle i, which is a vector or a scalar;
$$\frac{\partial {ϕ}_{j}}{\partial n}$$
is a partial derivative of an arbitrary parameter of the particle j in a direction of the normal vector of the particle j;
Internal is an internal particle;
Dirichlet is is a fixed-value boundary condition, comprising the pressure boundaries, the temperature boundaries and the velocity boundaries;
Neumann is a gradient boundary condition, comprising the heat flow boundaries, the pressure gradient boundaries, and the load boundaries;
wherein macroscopic state changes in velocity, position and energy of the actual calculation object under the thermal expansion, the elasticity, the plasticity, the creep and the fracture are obtained;
step 4: performing a thermal hydraulic calculation, comprising fluid motions under gravity, viscous forces, pressure and surface tensions, and fluid energy changes during heat transfer;
calculating the fluid motions according to an equation (13), so as to obtain velocity and position changes of fluid particles;
$$ρ \frac{d u}{d t} = - ∇ P + {μ}_{f} {∇}^{2} u + ρ f + ρ g \qquad equation ( 13 )$$
wherein
t is time, s;
ρ is a density, kg/m³;
u is a velocity vector, m/s;
P is a pressure, Pa;
μ_{f} is a dynamic viscosity, Pa·s;
f is a surface tension vector, N/kg;
g is a gravitational acceleration vector, m/s²;
wherein a gradient term of the pressure and a velocity Laplace term of a viscosity term uses the advanced particle method in the discrete form as shown in the equations (6) to (12), and the pressure is calculated by implicit iterative solution of a pressure Poisson equation, as shown in an equation (14):
$$\frac{1}{ρ} {( {∇}^{2} {P}^{k + 1} )}_{i} = \frac{1 - ξ}{Δ t} ∇ \cdot {u}^{*} - \frac{ξ}{Δ {t}^{2}} ( \frac{{n}^{*} - {n}^{0}}{{n}^{0}} ) \qquad equation ( 14 )$$
wherein
n* is a temporary particle number density, which is calculated from particle position obtained by calculating a gravity term, the viscosity term and a surface tension term for the particle;
ξ is a pressure Poisson's equation weighting coefficient, ranging from 0 to 1;
Δt is a time step, s;
u* is a temporary velocity vector, m/s;
P^{k+1} is a pressure value at a time step k+1, Pa;
∇is a Hamiltonian arithmetic;
wherein during a discretization process of the advanced particle method, a dynamic viscosity in the viscosity term adopts a harmonic average of the dynamic viscosity, as shown in an equation (15)
$${μ}_{ij} = \frac{2 {μ}_{i} {μ}_{j}}{{μ}_{i} + {μ}_{j}} \qquad Equation ( 15 )$$
wherein
μᵢⱼ is a dynamic viscosity between the particle i and the particle j, Pa·s;
μᵢ is a dynamic viscosity of the particle i, Pa·s;
μⱼ is a dynamic viscosity of the particle j, Pa·s;
calculating the surface tension with a free energy model based on a surface tension model, as shown in an equation (16)
f=F(rᵢⱼ−rₘᵢₙ)(rᵢⱼ−rₑ)/m equation (16)
wherein
f is a surface tension vector, N/kg;
m is a mass, kg;
F is a free energy coefficient;
rₘᵢₙ is a minimum distance of the particle i from surrounding particles, adopting 1.5 l₀;
rₑ is a particle radius of action;
wherein a fluid heat transfer process calculation comprises radiation, heat conduction, convection, heat flow boundaries and chemical heat as shown in an equation (17), from which energy changes of the fluid particles are calculated;
$$ρ \frac{\partial H}{\partial t} = {ρ ( \frac{\partial H}{\partial t} )}_{Trans} + {ρ ( \frac{\partial H}{\partial t} )}_{radiation} + {Q}_{heatflow} + {Q}_{chem} \qquad equation ( 17 )$$
wherein
H is an enthalpy, J/kg;
ρ is a density, kg/m³;
Q_{heatflow} is a volume heat flow boundary, W/m³;
Q_{chem} is chemical heat, W/m³;
$${( \frac{\partial H}{\partial t} )}_{T r a n s}$$
is a partial derivative of the enthalpy against time due to the heat conduction and convective heat exchange, W/kg;
$${( \frac{\partial H}{\partial t} )}_{radiation}$$
is a partial derivative of the enthalpy against time due to radiative heat exchange, W/kg;
wherein a partial derivative calculation of the enthalpy against time due to the heat conduction and the convective heat transfer uses a thermal conductivity differential equation, as shown in an equation (18); in the advanced particle method, the heat conduction and the convection use a same set of models; for the heat conduction, the particles do not move; and for the convection, the particles move; a temperature Laplace term in the equation (18) uses the advanced particle method in the discrete form as shown in the equations (6) to (12), the thermal conductivity during a discrete process adopts a harmonic average;
$${( \frac{\partial H}{\partial t} )}_{Trans} = \frac{k}{ρ} {∇}^{2} T \qquad equation ( 18 )$$
wherein
k is the thermal conductivity, W/(m·K);
T is the temperature, K;
calculating the radiative heat exchange according to an equation (19):
$${( \frac{\partial H}{\partial t} )}_{radiation} = \frac{{εσ}_{s} ( {T}_{i}^{4} - {T}_{j}^{4} )}{ρ {l}_{0}} \qquad equation ( 19 )$$
wherein
ε is an emissivity;
σₛ is a Stefan-Boltzmann constant;
Tᵢ is the temperature of the particle i, K;
Tⱼ is a temperature of the particle j, K;
determining the heat flow boundaries according to an actual situation, comprising heat source and the cooling boundaries;
determining the chemical heat by chemical reactions;
wherein changes of fluid particle velocities, positions and energy are calculated in the step 4, which truly reflect fluid motion and temperature field changes of the calculation object during the serious accident in an actual nuclear reactor;
step 5: performing a chemical reaction calculation, comprising redox reactions, eutectic reactions and corrosion phenomena, wherein the redox reactions determine a material change rate based on a reaction rate, the eutectic reactions are determined based on a diffusion rate, and the corrosion phenomena are determined by a corrosion rate; the chemical reaction calculation relays on a nuclear reactor material database;
wherein the step 5 calculates the material component changes of a core material under the chemical reactions, and truly reflects chemical reaction effects on the severe accident in the nuclear reactor through the material property changes;
step 6: performing a neutron physics calculation using a multigroup approximation S_{N} difference Boltzmann transport equation as shown in an equation (20)
$$Ω \cdot ∇ ϕ ( r , Ω , {E}_{n} ) + {\sum }_{t} ϕ ( r , Ω , {E}_{n} ) = \int \int {\sum }_{s} ( r , {Ω}^{′} , {E}_{n}^{′} \to Ω , {E}_{n} ) ϕ ( r , {Ω}^{′} , {E}_{n}^{′} ) d {Ω}^{′} {dE}_{n}^{′} + \frac{χ ( r , {E}_{n} )}{4 π} \int \int v {\sum }_{f} ( r , {Ω}^{′} , {E}_{n}^{′} ) ϕ ( r , {Ω}^{′} , {E}_{n}^{′} ) d {Ω}^{′} d {E}_{n}^{′} + \frac{Q ( r , {E}_{n} )}{4 π} \qquad equation ( 20 )$$
wherein
Ω is a direction vector;
Ω′ is another direction vector, but different from Ω;
ϕ(r,Ω,Eₙ) is a neutron angular flux density when an input is r,Ω,Eₙ;
ϕ(r,Ω′,E′ₙ) is a neutron angular flux density when the input is r,Ω′,E′ₙ;
Σₜ is a total neutron cross section;
Q(r,Eₙ) is neutron source intensity;
Eₙ is neutron energy;
E′ₙ is another neutron energy, but different from Eₙ;
Σₛ(r,Ω′,E′ₙ→Ω,Eₙ) is a scattering cross section;
χ(r,Eₙ) is a fission spectrum;
ν is a quantity of neutrons released per fission;
Σ_{f}(r,Ω′,E′ₙ) is a neutron fission cross section;
selecting a multi-group core cross-section database according to an actual calculation reactor type; arranging a structured grid on a core particle geometry arrangement, and adopting a coarse mesh finite difference method to accelerate solution; using a particle mesh mapping technology to realize grid-particle information interaction;
wherein the step 6 calculates the neutron angular flux density in the core, and changes a heat source distribution in the core through the neutron angular flux density to change the material physical properties and material stress strain, thus realizing coupling analysis of neutron physics and thermal engineering hydraulics; and
step 7: outputting required data; determining whether an end-of-calculation condition is met, if not, advancing the time step and returning to the step 2, if yes, ending calculation;
wherein the steps 1-7 are used to analyze the severe accident in the nuclear reactor, which integrate possible key factors during the severe accident in the nuclear reactor, comprising the mechanical structure changes, the fluid motions, heat transfer phase changes, the chemical reactions and the neutron physics, so as to analyze key phenomena of the severe accident in the nuclear reactor, mainly comprising: core heating transients, core melting, melt migration, debris bed behavior, core melt retention behavior, melt-concrete interaction, and melt-coolant interaction.

2. The method, as recited in claim 1, which is based on the discrete form of the advanced particle method for accurately capturing cross-sectional changes, matter changes, and phase changes.

3. The method, as recited in claim 1, which is based on the discrete form of the advanced particle method to effectively avoid a mesh distortion problem existing in a large deformation.
